(19) United States
(12) Patent Application Publication
(10) Pub. No.: US 2008/0304473 A1
(43) Pub. Date: Dec. 11, 2008

(54) Enhanced terminal adapter

(75) Inventor: Jeffrey J. Farah, North Brunswick, NJ (US)

Correspondence Address: AT&T CORP., ROOM 2A207, ONE AT&T WAY, BEDMINSTER, NJ, 07921, US

(73) Assignee: AT&T Corp.

(21) Appl. No.: 11/811,678

(22) Filed: Jun. 11, 2007

(51) Int. Cl. H04L 12/66

(52) U.S. Cl. 370/352

(57) ABSTRACT

An enhanced terminal adapter (ETA) allows multiple communication devices connected to either similar or dissimilar networks, and typically accessible through different access numbers/addresses, to be used as extensions of each other when any of the devices are accessed via their access number/address. In the case of a PSTN call, communications devices connected to the ETA are considered POTS extensions. For a VoIP call, the communications devices connected to the ETA could be considered enhanced extensions in a VoIP network. In this way, the communications devices are each extensions of each other, depending on which device is accessed.

### FIELD OF THE INVENTION

The present invention relates generally to telecommunications, and more particularly to terminal adapters in telecommunication networks.

### BACKGROUND OF THE INVENTION

A terminal adapter (TA) is an interface between a communications device (e.g., a computer, etc.) and a Modern Digital Network (MDN) (e.g., an IP network, a digital PSTN, an ISDN, etc.). Unlike plain old telephone service (POTS), which carries voice signals in analog form between telephones via a network, an MDN carries signals in digital form so there is no need to modulate and demodulate between analog and digital signals, except as required, for example, from an input microphone/telephone mouthpiece, or an output speaker or headset. The terminal adapter may be installed on a computer so that data can be fed directly into the ISDN line in digital form. It should be noted that TAs are also referred to loosely as ISDN modems or ISDN routers. It should be further noted that some devices referred to as TAs may incorporate the structures and functions of a traditional modem along with those of a TA.

In modern communications, a user or set of users (e.g., a company) often has multiple communications devices connected on multiple networks, each having its own access number. Such communications devices having unique access numbers include: mobile telephones having a Mobile Identification Number (MIN) and Electronic Serial Number (ESN); wired telephones (e.g., telephones connected to a public switched telephone network (PSTN)) having a telephone number; and Personal Computers (PCs) and Voice over Internet Protocol (VoIP) devices having Internet Protocol (IP) addresses, among other devices. Since each of the communications device has its own access number, calls connected to these devices are considered to be on separate channels (e.g., telephone lines). That is, each communications device is accessed via its own access number and is therefore not an extension of any other communications device.

Communications devices may be functionally linked by call forwarding (e.g., call diverting), multiple party calling, or the like, but calls to the separate communications devices remain on separate channels. In the case of call forwarding, a first communications device is contacted via its access number and the first communications device or the underlying network forwards the call to a second communications device. When the call is received at the second communications device, the call (e.g., the line, channel, etc.) is no longer available to the first communications device. That is, the ability to simply pick-up the call at the first communications device is lost. Similarly, in multiple party calling, one or more communications devices are connected using their respective access numbers. While multiple devices may then be in communication with each other, each communications device remains separate and does not become an extension of any of the other devices.

Since each of the communications devices in traditional communications systems are separate, users with more than one communications device must choose a device for use in a particular call and cannot easily switch between devices. Therefore, alternative apparatus and methods are required to facilitate using other communications devices.

### SUMMARY OF THE INVENTION

The present invention provides improved methods and apparatus for telecommunications. A terminal adapter has one or more communications ports to connect to one or more communications devices and may possess one or more network interface ports to connect to various networks. The terminal adapter also has a controller configured to functionally link the communications devices such that the communications devices are extensions of each other. The terminal adapter may functionally link the devices by routing incoming calls received at either the terminal adapter or any of the communications devices to any communications device connected to the terminal adapter.

In some embodiments, the terminal adapter is addressable by one or more access numbers and the communications devices are each addressable by a respective access number. In such cases, the terminal adapter is configured to store and use the access numbers so that a call addressed to any of the access numbers (e.g., to any of the communications devices) is routed through the terminal adapter to one or more of the communications devices connected to the terminal adapter.

These and other advantages of the invention will be apparent to those of ordinary skill in the art by reference to the following detailed description and the accompanying drawings.

### BRIEF DESCRIPTION OF THE DRAWINGS

FIG. 1 depicts a communications network in accordance with an embodiment of the present invention;

FIG. 2 depicts an enhanced terminal adapter in accordance with an embodiment of the present invention; and

FIG. 3 depicts a flowchart of a method of communication in accordance with an embodiment of the present invention.

### DETAILED DESCRIPTION

The present invention generally provides methods and apparatus for enabling extension connectivity between multiple communications devices. An Enhanced Telecommunications/Terminal adapter (ETA) is provided that allows multiple communication devices to be used as extensions of one or more channels (e.g., communications lines). Generally, an extension is an additional communications device connected to a line or line group and a line or line group is a connection (e.g., wired and/or wireless) between two or more communications devices. Extension functionality allows two or more devices (e.g., communications devices) to be served by the same communications line or group. Further, a call may be considered to be any received and/or sent communications transmission such as a traditionally connected telephone call, a voice call, a data call, a VoIP call, a wireless transmission, transmission of packet information in a packet-switched network, a Bluetooth or similar transmission, etc.

Communications devices connected to the ETA are considered Plain Old Telephone Service (POTS) extensions in the case of a Public Switched Telephone Network (PSTN) or enhanced extensions in a Voice over Internet Protocol (VoIP) network. In other words, when the PSTN is the underlying network (e.g., the network that carries the call) to which the ETA is connected, communications devices connected to the ETA are considered to be connected through (e.g., are extensions of) a traditional wired telephone line. When the underlying network is a VoIP network (e.g., the Internet), communications devices connected to the ETA are considered to be connected through VoIP or other appropriate protocol and are enhanced extensions. An enhanced extension may be an extension that can provide multiple services and independent addressing in addition to standard telephonic communication and can provide telephony, multimedia, text, etc.; for example, a VoIP connection may be an enhanced extension. In this way, the communications devices are each extensions of each other, regardless of which device is initially accessed.

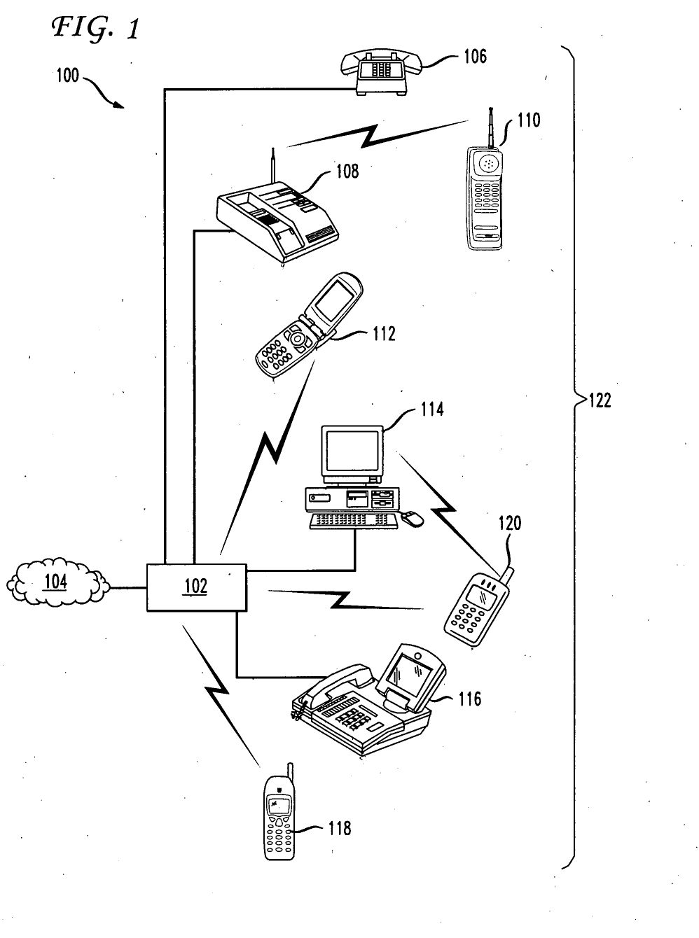

FIG. 1 depicts a telecommunication system 100 according to an embodiment of the present invention. An Enhanced Telecommunications/Terminal adapter (ETA) 102 is configured to connect to one or more networks 104. The ETA 102 also is configured to connect (e.g., communicatively connect, connect wirelessly, connect via a wire, etc.) to one or more of a wired telephone 106, a cordless base 108 and cordless handset 110, a mobile telephone 112, a PC 114, a video telephone 116, a wireless handheld device 118, and/or a VoIP handset 120 (that may also connect to PC 114), among other communications devices. Hereinafter, wired telephone 106, cordless base 108 and cordless handset 110, mobile telephone 112, PC 114, video telephone 116, wireless handheld device 118, and VoIP handset 120 are collectively referred to as communications devices 122.

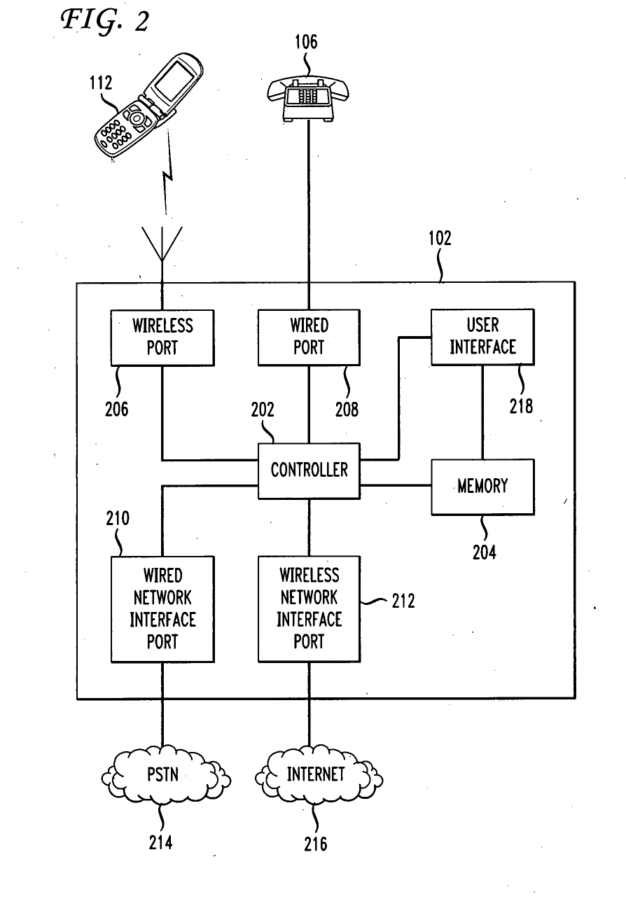

ETA 102 may be a traditional TA for installation at a subscriber (e.g., customer) premises further configured to perform the functions of the present invention. That is, ETA 102 may be a TA, ISDN modem, ISDN router, voiceband modem, VoIP TA, 802.11 enabled TA/Router, 802.16 enabled TA/Router, or other similar device or combination of devices (e.g., a combination TA and traditional modem, or a combination TA and router). Accordingly, ETA 102 is configured to connect to a PSTN, a VoIP network, other networks, and/or any communications devices. Such TAs are well known in the art and will tot be discussed in detail herein except for improvements by embodiments of the present invention. An exemplary ETA 102 is described below with respect to FIG. 2.

Network 104 may be a PSTN, the Internet, a VoIP network, a combination of these networks, and/or any other appropriate network. Thus, ETA 102 may connect to any appropriate network 104 to transmit and/or receive telephone calls and/or other information (e.g., video information for video telephone 116, visual information for display at PC 114, etc.). In some embodiments, ETA 102 may connect to more than one network as shown more explicitly in FIG. 2.

Communications devices 122 may be any communications device capable of handling a call. Such devices may further include Blackberrys, Personal Digital Assistants (PDAs), laptop computers, etc. Generally, each communications device 122 may have an associated access number. In exemplary embodiments, mobile telephone 112 may have an associated MIN and ESN, wired telephone 106 and/or ETA 102 may have a ten-digit telephone number, and PC 114 may have an IP address. Other access numbers and/or methods of accessing individual communications devices 122 (e.g., accessing cordless handset 110 via a handset number available through cordless base 108) may be used. Though not explicitly shown in FIG. 1, it may be understood that any of communications devices 122 may connect directly to the network 104 and/or each other.

FIG. 2 depicts a ETA 102 according to an embodiment of the present invention. ETA 102 has a controller 202 (e.g., microprocessor, etc.) operatively coupled to a memory 204. Also coupled to the controller 202 are one or more communications ports, such as wireless port 206 and/or wired port 208. Wireless port 206 and wireless port 208 may be capable of connecting to one or more communications devices 122 of FIG. 1. For illustrative purposes, mobile telephone 112 is shown connected to (e.g., able to interface and/or communicate with) wireless port 206 and wired telephone 106 is shown connected to wired port 208, though any appropriate communications device 122 may be coupled to either of wireless port 206 and/or wired port 208.

ETA 102 further comprises one or more network interface ports coupled to the controller 202, such as wired network interface port 210 and/or wireless network interface port 212. Wired network interface port 210 and wireless network interface port 212 may be connected a network (e.g., network 104 of FIG. 1) such as PSTN 214 and the Internet 216, respectively. Additionally, a user interface 218 is coupled to the controller 202 and/or the memory 204.

In some embodiments, components of ETA 102 may be implemented on and/or may include any components or devices that are typically used by, or used in connection with, a computer, software, or computer system. Although not explicitly pictured in FIG. 2, ETA 102, controller 202, and/or memory 204 may include one or more central processing units, read only memory (ROM) devices, and/or random access memory (RAM) devices as necessary to their respective functions.

Controller 202 and/or memory 204 may include one or more databases for storing any appropriate data and/or information such as access numbers and/or one or more programs or sets of instructions for executing methods of the present invention. Accordingly, controller 202 and/or memory 204 may aggregate and store access numbers or other means of accessing a communications device 122 such that ETA 102 becomes a “virtual” version of the communications device 122. That is, when an access number associated with a communications device 122 is stored in memory 204 and the communications device 122 is communicatively connected (e.g., wired, wirelessly, etc.) to the ETA 102, any call placed to the communications device 122 is routed to the ETA 102, the originally called communications device 122, and/or any other communications devices 122 connected to the ETA 102. These calls may be routed by the communications device 122 (e.g., PC 114 may redirect a VoIP call over Internet 216 to the controller 202), by the ETA 102 (e.g., the redirected call received at ETA 102 from PC 114 may be rerouted by controller 202 to wired telephone 106), and/or by the network 104 (e.g., a wireless call directed to mobile telephone 112 may be routed by network 104 to the MIN and/or ESN associated with the mobile telephone 112, which has also been associated with the ETA 102, thereby routing the call to both devices simultaneously).

According to some embodiments of the present invention, instructions of a program (e.g., controller software) may be read into memory 204 of ETA 102 from another medium, such as from a ROM device to a RAM device or from a LAN adapter to a RAM device. Execution of sequences of the instructions in the program may cause ETA 102 to perform one or more of the method steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software. The memory may store the software for the controller, which may be adapted to execute the software program and thereby operate in accordance with the present invention and particularly in accordance with the methods described in detail below. However, it would be understood by one of ordinary skill in the art that the invention as described herein could be implemented in many different ways using a wide range of programming techniques as well as general purpose hardware sub-systems or dedicated controllers.

The program may be stored in a compressed, uncompiled and/or encrypted format. The program furthermore may include program elements that may be generally useful, such as an operating system, a database management system and device drivers for allowing the ETA 102 to interface with computer peripheral devices and other equipment/components such as communications devices 122. Appropriate general purpose program elements are known to those skilled in the art, and need not be described in detail herein.

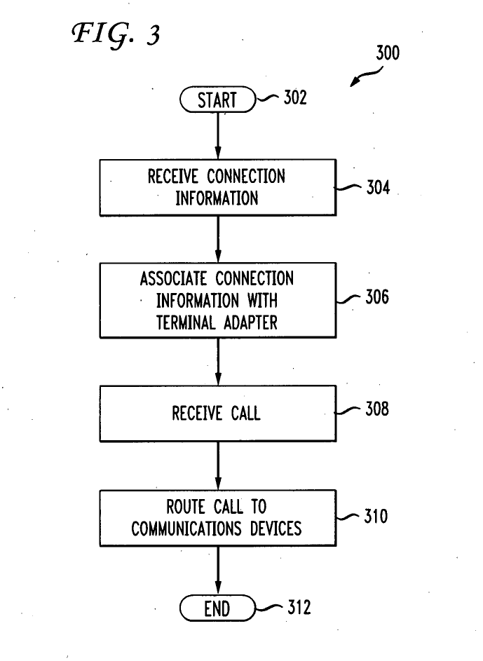

Wireless port 206 and wired port 208 may be any appropriate connection from the ETA 102 to the communications devices 122, respectively. ETA 102 may comprise one or more of each of wireless port 206 and wired port 208 and such connections may include pre-existing wire connections, cable networks, Ethernet connections, and/or local wireless networks. Wireless ports 206 may connect to wireless communications devices (e.g., mobile telephone 112) via a path (e.g., channel) separate from traditional telecommunications paths such as using a Bluetooth or other wireless signal. This connection may facilitate routing, extending, and/or handing off of a call to ETA 102 in accordance with features of the invention discussed in more detail with respect to FIG. 3 and method 300.

For example, ETA 102 may be connected through wired port 208 by a telephone wire to wired telephone 106 and to cordless base 108 (which may, in turn, wirelessly connect to cordless handset 110), but connected wirelessly through wireless port 206 to mobile telephone 112 and wireless handheld device 118. Communications devices 122 may also be connected to ETA 102 through other devices and methods, such as routers and local networks. Any appropriate connection method and/or device may be used to allow ETA 102 to extend extension functionality to communications devices 122.

Similarly, ETA 102 may connect to one or more networks such as through any number of wired network interface ports 210 to PSTN 214 or through any number of wireless network interface ports 212 to Internet 216. It may be understood that ETA 102 may connect to any network or combination of networks, as shown in FIG. 1 where ETA 102 connects to network 104 (e.g., through wired network interface port 210 and/or wireless network interface port 212).

User interface 220 may be any interface by which a user can interact with, configure, or otherwise control functionality of ETA 102. Exemplary user interfaces 220 include a touch screen, keypad, switches, etc. A user may, via user interface 220, configure ETA 102 to accept one or more of communications devices 122 as an extension of ETA 102 and/or another of communications devices 122. In some embodiments, a user may indicate connection of a communications device 122 to controller 202 via user interface 220 and/or may enter an access number for a communications device 122 at user interface 220, which may transfer the access number to one or more of the controller 202 and/or the memory 204.

Though shown as a component of ETA 102 in FIG. 2, user interface 220 may be included in a separate device (e.g., PC 114, etc.). In the same or alternative embodiments, user interface 220 may be implemented as a call-in feature from a communications device 122 to be connected to the ETA 102. That is, a user may contact (e.g., call with mobile telephone 112, contact with PC 114, etc.) ETA 102 from a communications device 122 (e.g., access a command menu stored at controller 202 and/or memory 204) and turn on extension functionality of that communications device 122.

In operation, ETA 102 may be user configurable to link one or more of the communications devices 122 as into a local network, similar to a Private Branch Exchange (PBX) or other like exchange. A user may, using user interface 220, set ETA 102 to allow incoming calls to the ETA 102 (e.g., calls directed to its associated access number) and/or one or more of the communications devices 122 (e.g. via their respective access numbers) to be available (e.g., as extensions) to all of the other devices 102, 124 currently connected to the local network and/or the ETA 102.

The user interface 220 and/or controller 202 may then transfer the access numbers to the memory 204 for later recall. The controller 202 may route any calls directed to the access numbers stored in memory 204 to all of the devices associated with the stored access numbers. In some embodiments, an incoming call directed to the access number corresponding to the ETA 102 may be routed by controller 202 to all of the communications devices 122 connected to the ETA 102. Similarly, an incoming call directed to the access number corresponding to, for example, the mobile telephone 112 may be routed by the controller 202 to the mobile telephone 112 as well as any other communications devices 122 connected to ETA 102.

In this way, the ETA 102 serves to create a local PBX amongst disparate communications devices 122 even as these devices are separately accessible and/or addressable via their respective access numbers. Accordingly, any communications device 122 connected to the ETA 102 may be accessed (e.g., contacted) through all of the other communications devices 122 connected to the ETA 102 and their respective access numbers, giving multiple access methods for the ETA 102 and the communications devices 122. Also, communications devices 122 communicatively connected to ETA 102 may receive calls originally directed to all of the communications devices 122 such that each communications device 122 may function as a standard telephone extension and may be answered (e.g., the call may be picked up) alone and/or simultaneously with any other communications device 122 connected to ETA 102.

For example, the user may input the telephone number associated with wired telephone 106 and the MIN and/or ESN associated with mobile telephone 112 at user interface 220. The user interface 220 may then transfer the telephone number and the MIN and/or ESN to the memory 204 for later recall. The controller 202 may then route any calls directed to the access numbers stored in memory 204 (e.g., access numbers of: ETA 102, wired telephone 106, and mobile telephone 112) to all of the devices associated with the stored access numbers. Thus, a call directed to wired telephone 106 is also routed by ETA 102 via wireless port 206 to mobile telephone 112 and both wired telephone 106 and mobile telephone 112 would be on the same channel/telephone line.

In some embodiments, ETA 102 may have VoIP functionality and may exploit the nature of IP communication to link communications devices 122 as extensions of the accessed (e.g., called) device (e.g. ETA 102). Similarly, ETA 102 may connect to a POTS network and each extension (e.g., communications devices 122) may be addressable via a base station (e.g., similar to cordless base 108 accessing multiple cordless handsets 110 using a handset number).

Turning to FIG. 3, communications network 100 of FIG. 1 and ETA 102 of FIGS. 1 and 2 may be used in a method of communication 300. The method 300 begins at step 302.

In step 304, the ETA 102 receives connection information for a plurality of communications devices 122. Connection information may be any appropriate identifying information, such as a corresponding access number, which facilitates connection of a received call to a communications device 122. The received connection information is then stored for later retrieval and use.

For example, a user inputs connection information such as a MIN and/or ESN associated with mobile telephone 112 and a ten digit telephone number associated with wired telephone 106 using user interface 220. The MIN and/or ESN and telephone number are then transferred to and stored in memory 204.

In step 306, the connection information (e.g., the access numbers) is associated with the ETA 102. Here, the ETA 102 makes the networks 104 aware (e.g., notifies) that it is associated with the stored access numbers and any calls directed to the communications devices 122 associated with those access numbers should also be routed to ETA 102. That is, switching centers (e.g., mobile switching centers (MSCs) and/or telephone switches in a PSTN) responsible for managing calls will treat ETA 102 as the communications device to which the call is directed.

In step 308, a call is received. The call may be received from the network 104 (e.g., PSTN 214 and/or Internet 216) at ETA 102 and/or communications devices 122. An incoming call may be routed by network 104 to all devices associated with the access number corresponding to the intended recipient device. Since the ETA 102 was associated with the access number in step 306, the network 104 may route the incoming call to both ETA 102 and the intended recipient communications device 122. Similarly, an outbound call (e.g., a placed call) may be routed over the network 104 and the connection of such a call may be considered a received call. Thus, the call may be received at the ETA 102 or one of communications devices 122.

In the same or alternative embodiments, a communications device may route the received call to the ETA 102. For example, a call received at mobile telephone 112 over PSTN 214 may be routed by mobile telephone 112 over PSTN 214 to ETA 102.

In step 310, ETA 102 routes the received call to all communications devices 122 connected to the ETA 102. This routing connects ETA 102 with all connected communications devices 122 on one line for the call. That is, each of communications devices 122 are functionally linked such that the other communications devices 122 perform as extensions of the communications device 122 to which the call was originally directed. In this way, each of the communications devices 122 may pick up, handle, conference, hang up, and otherwise interact with the received call as is conventional in a PBX or other extension functionality. As discussed above, an outgoing call may be considered to be a received call such that when an outgoing call is placed (e.g., the call is received at a separate device) using one communications device 122 that is connected to ETA 102, the call is available to all other communications devices 122 connected to ETA 102 as extensions of the first communications device 122.

For example, an incoming call directed by the network 104 to mobile telephone 112 (e.g., identified by a corresponding MIN) is also directed to ETA 102 and is subsequently routed to wired telephone 106, cordless base 108 and cordless handset 110, PC 114, video telephone 116, and wireless handheld device 118 by ETA 102. All communications devices 122 may then ring simultaneously and communications devices 106-110 and 114-118 may functionally perform as extensions of mobile telephone 112.

Continuing the example, the call directed to the mobile telephone 112 may be answered by a user using the extension—wired telephone 106. This may be advantageous in situations where wireless service is poor, but wired service is functioning properly. The answered wired telephone 106 serves as an extension of mobile telephone 112 through ETA 102. This may be advantageous in situations where the network 104 has a better connection (e.g., a wired connection) to ETA 102 than to mobile telephone 112. The network 104 may route the incoming call to ETA 102 and mobile telephone 112 (since ETA 102 is associated with the MIN and/or ESN of mobile telephone 112 as in step 306) and ETA 102 may, in turn, route the call to wired telephone 106. Accordingly, another user may take mobile telephone 112 to another area with better coverage and pick up the call in progress. The second user using the mobile telephone 112 may join the call with the first user using the wired telephone 106 and the incoming caller. The first user using the wired telephone 106 may terminate the call without interrupting the call of the second user using the mobile telephone 112, as is customary with telephone extensions. Other features and uses of telephone extension service may be employed.

In some embodiments, the linked communications devices may retain functionality as independent call recipients and senders even while linked to the ETA 102 and/or participating in a call. In such embodiments, the method 300 may return control to step 308 to receive further calls.

In the above example, a third user may join the call on a linked wireless handheld device 118. During the course of the call, wireless handheld device may receive an incoming call addressed to the wireless handheld device 118 by an associated MIN and/or ESN as in step 208. The user using wireless handheld device 118 may choose to disconnect from the current call and connect to the new call. Similarly, other devices linked through ETA 102 may join one or both of the calls in progress on mobile telephone 112 and wired telephone 106 or wireless handheld device 118. In the same or alternative embodiments, the ETA 102 may facilitate linking the multiple incoming calls. Other variations on extension service may be employed as appropriate.

The method ends at step 312. Other calling features are well-known in the art and are accordingly not discussed in detail herein, though any appropriate methods of telephone usage may be used in conjunction with method 300 and the communications network 100 of FIG. 1 and terminal adapter 102 of FIG. 2.

In some embodiments, a user may decouple a communications device 122 from the ETA 102 so that the communications device 122 will no longer be considered an extension of the ETA 102, nor of any other communications devices 122. The decoupled communications device 122 may subsequently be linked to a different ETA 102 to enable similar functionality with a new local network. This may be accomplished by performing variations of method steps 304 and 306. A user may use user interface 220 to disassociate the connection information associated with the communications device and the controller 202 and/or memory 204 may purge the information or otherwise disregard command to route calls to the disassociated communications device.

The foregoing description discloses only particular embodiments of the invention; modifications of the above disclosed methods and apparatus which fall within the scope of the invention will be readily apparent to those of ordinary skill in the art.

For instance, it will be understood that, though discussed primarily as standard telephone access, use of PC 114 to connect to the Internet to place VoIP calls may be used in conjunction with a POTS telephone, thus mixing PSTN and Internet networks, TAs, modems, and associated calling features. This encourages merging of previously disparate telephone networks into a converged communications environment. Further, it may be understood that any number of communications devices 122 connected to ETA 102 may be configured as extensions. For example, though ten devices may be connected to the ETA at moment in time, a user may wish to only allow four of those devices to serve as extensions of each other. Similarly, the user may wish to have a different four of the ten devices serve as extensions of each other and leave the remaining two devices unassociated as extensions. Still further, the present invention facilitates adoption of multiple types of service and allows cross-connect between these services. This may reduce customer cost and greatly improve efficiency (e.g., by creating local networks) and functionality.

Accordingly, while the present invention has been disclosed in connection with specific embodiments thereof, it should be understood that other embodiments may fall within the spirit and scope of the invention, as defined by the following claims.

What is claimed is:

1. A terminal adapter comprising:
a plurality of communications ports configured to connect to a plurality of communications devices; and
a controller configured to route calls to at least one of the plurality of communications devices such that the at least one of the plurality of communications devices operates as an extension of one or more of the remaining communications devices.

2. The terminal adapter of claim 1 further comprising:
one or more network interface ports configured to connect to one or more networks.

3. The terminal adapter of claim 2 wherein calls are received from the network at the terminal adapter through the one or more network interface ports.

4. The terminal adapter of claim 1 wherein the terminal adapter is addressable by one or more access numbers and the communications devices are each addressable by a respective access number.

5. The terminal adapter of claim 4 further comprising:
a memory configured to store the one or more access numbers of the terminal adapter and the respective access numbers of at least one of the communications devices.

6. The terminal adapter of claim 4 wherein the terminal adapter is further configured to receive a call directed to the access number of at least one of the communications devices.

7. The terminal adapter of claim 6 wherein the controller is further configured to route the call according to the stored respective access numbers of at least one of the communications devices.

8. A method of operation of a terminal adapter comprising:
receiving a call placed to a first of a plurality of communications devices connected to a terminal adapter; and
routing the call to at least one of the other communications devices connected to the terminal adapter so that the at least one of the other communications devices operates as an extension of the first communications device.

9. The method of claim 8 further comprising:
receiving connection information for at least one of the plurality of communications devices at the terminal adapter.

10. The method of claim 9 wherein the connection information is a respective access number for at least one of the plurality of communications devices.

11. The method of claim 9 further comprising:
associating the connection information with the terminal adapter.

12. The method of claim 11 wherein associating the connection information with the terminal adapter comprises:
notifying one or more networks to route calls intended for at least one of the plurality of communications devices to the terminal adapter.

13. The method of claim 8 wherein receiving a call placed to a first of a plurality of communications devices connected to a terminal adapter comprises:
receiving a call at the first communications device and at the terminal adapter.

14. The method of claim 8 wherein routing the call to at least one of the other communications devices connected to the terminal adapter comprises:
functionally linking the plurality of communications devices in a private branch exchange.

15. A machine readable medium having program instructions stored thereon, the instructions capable of execution by a processor and defining the steps of:
receiving a call placed to a first of a plurality of communications devices connected to a terminal adapter; and
routing the call to at least one of the other communications devices connected to the terminal adapter so that at least one of the other communications devices operates as an extension of the first communications device.

16. The machine readable medium of claim 15, wherein the instructions further define the step of:
receiving connection information for at least one of the plurality of communications devices at the terminal adapter.

17. The machine readable medium of claim 16, wherein the connection information is a respective access number for at least one of the plurality of communications devices.

18. The machine readable medium of claim 15, wherein the instructions further define the step of:
associating the connection information with the terminal adapter.

19. The machine readable medium of claim 18, wherein the instructions for associating the connection information with the terminal adapter further define the step of:
notifying one or more networks to route calls intended for the at least one of the plurality of communications devices to the terminal adapter.

20. The machine readable medium of claim 15, wherein the instructions for receiving a call placed to one of a plurality of communications devices connected to a terminal adapter further define the step of:
receiving a call at one of the plurality of communications devices and at the terminal adapter.

21. The machine readable medium of claim 15, wherein the instructions for routing the call to at least one of the other communications devices connected to the terminal adapter further define the step of:
functionally linking the plurality of communications devices in a private branch exchange.

22. An apparatus comprising:
means for receiving a call placed to a first of a plurality of communications devices connected to a terminal adapter; and
means for routing the call to at least one of the other communications devices connected to the terminal adapter so that at least one of the other communications devices operates as an extension of the first communications device.

23. The apparatus of claim 22 further comprising:
means for receiving connection information for at least one of the plurality of communications devices at the terminal adapter.

24. The apparatus of claim 23 wherein the connection information is a respective access number for each of the plurality of communications devices.

25. The apparatus of claim 22 further comprising:
means for associating the connection information with the terminal adapter.

26. The apparatus of claim 25 wherein the means for associating the connection information with the terminal adapter comprises:
means for notifying one or more networks to route calls intended for at least one of the plurality of communications devices to the terminal adapter.

27. The apparatus of claim 22 wherein the means for receiving a call placed to a first of a plurality of communications devices connected to a terminal adapter comprises:
means for receiving a call at the first communications device and at the terminal adapter.

28. The apparatus of claim 22 wherein the means for routing the call to at least one of the other communications devices connected to the terminal adapter comprises:
means for functionally linking the plurality of communications devices in a private branch exchange.
